(19) United States
(12) Patent Application Publication
(10) Pub. No.: US 2016/0149628 A1
(43) Pub. Date: May 26, 2016

(54) CHANNEL STATE INFORMATION (CSI) REPORTING FOR CARRIER AGGREGATION

(71) Applicant: Intel Corporation, Santa Clara, CA (US)

(72) Inventors: Alexei Davydov, Nizhny Novgorod (RU); Gregory Morozov, Nizhny Novgorod (RU); Hong He, Beijing (CN); Alexander Maltsev, Nizhny Novgorod (RU)

(21) Appl. No.: 14/692,987

(22) Filed: Apr. 22, 2015

Related U.S. Application Data
(60) Provisional application No. 62/084,068, filed on Nov. 25, 2014.

(51) Int. Cl. H04B 7/06; H04B 7/04; H04W 72/04

(52) U.S. Cl. CPC H04B 7/0626; H04W 72/042; H04B 7/0632; H04B 7/0634; H04B 7/0486

(57) ABSTRACT

Channel state information (CSI) feedback of common CSI components is discussed. An example user equipment (UE) includes a receiver circuit, processor, and transmitter circuit. The receiver circuit is configured to receive CSI configuration information for a plurality of downlink (DL) cells that indicates a first group of two or more of the DL cells and at least one CSI component designated for common reporting for the first group. The processor is configured to calculate a group value for each of the at least one CSI components designated for common reporting for the first group and selectively calculate, for each DL cell of the first group, individual values for any CSI components not designated for common reporting for the first group. The transmitter circuit is configured to transmit the group value for each of the designated CSI components and the individual values for any additional CSI components.

### REFERENCE TO RELATED APPLICATIONS

This application claims the benefit of U.S. Provisional Application No. 62/084,068 filed Nov. 25, 2014, entitled “METHOD OF CSI REPORTING FOR CARRIER AGGREGATION”, the contents of which are herein incorporated by reference in their entirety.

### FIELD

The present disclosure relates to channel state information (CSI) reporting and more particularly to CSI reporting for a group of downlink (DL) cells via one or more common CSI components of the group of DL cells.

### BACKGROUND

Demand for high data rate wireless broadband transmission is increasing, with mobile data traffic expected to increase exponentially over the next decade. Carrier aggregation is a major tool to address this increased demand. Current Long Term Evolution (LTE)-Advanced (LTE-A) system design limits the maximum number of simultaneous downlink (DL) cells (or component carriers) used for carrier aggregation (CA) to five.

The existing constraint in LTE-A of a maximum of five component carriers (that can be simultaneously aggregated at the UE for the downlink traffic transmissions) is likely to be removed in the near future to accommodate new operation scenarios for LTE-A systems. The availability of a large chunk of spectrum in the unlicensed bands (e.g., at 5 GHz) makes it possible to consider LTE-A aggregation scenarios with a larger number of component carriers than 5, such as 8, 16, 32, etc.

### BRIEF DESCRIPTION OF THE DRAWINGS

FIG. 1 is a block diagram of a system that facilitates channel state information (CSI) reporting for a plurality of downlink (DL) cells at a user equipment (UE) according to various aspects described herein.

FIG. 2 is a block diagram of a system that facilitates CSI configuration for common CSI reporting on a plurality of DL cells at an Evolved NodeB (eNB) according to various aspects described herein.

FIG. 3 is a flow diagram of a method that facilitates CSI reporting for a plurality of DL cells at a UE according to various aspects described herein.

FIG. 4 is a flow diagram of a method that that facilitates CSI configuration for common CSI reporting on a plurality of DL cells at an eNB according to various aspects described herein.

FIG. 5 is a flow diagram of an example method of CSI reporting for a DL cell based on a common rank indicator (RI) according to various aspects described herein.

FIG. 6 is a flow diagram of an example method of CSI reporting for a DL cell based on a common RI and precoding matrix indicator (PMI) according to various aspects described herein.

FIG. 7 is a block diagram illustrating an example UE useable in connection with various aspects described herein.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

Embodiments described herein can provide for channel state information (CSI) feedback based on determination of one or more common CSI components shared between a group of downlink (DL) cells (component carriers). Aspects involving common CSI components can provide for reduced signaling overhead.

In conventional LTE-A systems, each CSI component (e.g., rank indicator (RI), precoding matrix indicator (PMI), channel quality indicator (CQI)) is individually calculated for each DL cell. However, as the number of DL cells increases, this can cause multiple issues.

For example, as the number of DL cells increases, the amount of overhead required for CSI feedback increases proportionally if done conventionally (with individual reporting for each DL cell). Generally, all CSI feedback is transmitted on a primary uplink component carrier. Although this is manageable for carrier aggregation (CA) involving up to five DL cells, this can become a significant issue if the number of DL cells increases further, e.g., to 8, 16, 32, etc.

Additionally, as the number of DL cells increases, coverage of the physical uplink control channel (PUCCH) or physical uplink shared channel (PUSCH) used for CSI reporting can become a problem. Theoretically, as the number of DL cells increases, the number of frequency resources used for CSI feedback could scale proportionally. However, user equipments (UEs) have limited transmit power. Thus, PUCCH coverage also becomes a more significant issue with increasing number of DL cells.

Another issue is the complexity and power consumption involved in calculating CSI feedback. CSI feedback is a relatively power-intensive operation, and increasing the number of DL cells beyond five can have a significant impact in terms of power consumption if CSI feedback is performed in a conventional manner involving calculation of all CSI components for each individual DL cell.

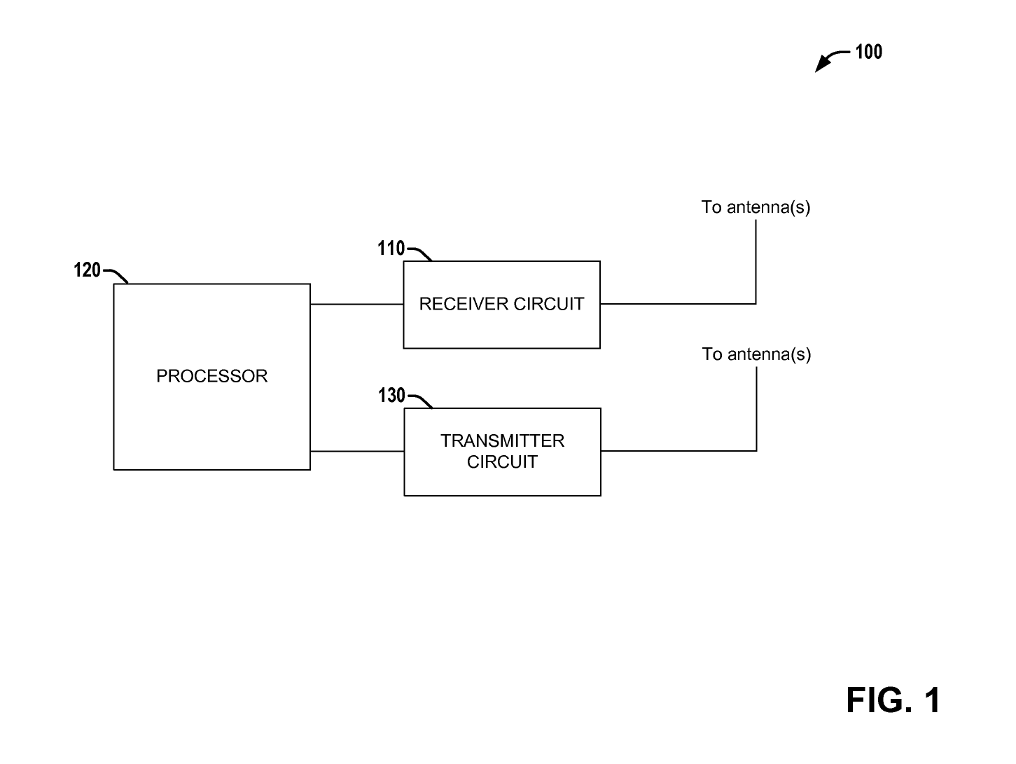

Referring to FIG. 1, illustrated is a block diagram of a system 100 that facilitates channel state information (CSI) reporting for a plurality of downlink (DL) cells at a user equipment (UE) according to various aspects described herein. System 100 can include a receiver circuit 110, a processor 120, and a transmitter circuit 130. Each of the receiver circuit 110 and the transmitter circuit 130 are configured to be coupled to one or more antennas, which can be the same or different antenna(s). In aspects, the receiver circuit 110 and transmitter circuit 130 can have one or more components in common, and both can be included within a transceiver circuit, while in other aspects they are not. In various aspects, system 100 can be included within a UE, for example, with system 100 (or portions thereof) within a receiver and transmitter or a transceiver circuit of a UE.

Receiver 110 can receive signals via a plurality of DL cells (component carriers) according to a carrier aggregation (CA) mode. Additionally, receiver 110 can receive CSI configuration information associated with the plurality of DL cells. The CSI configuration information can indicate one or more groups of DL cells for which common CSI reporting can be employed, and can designate, for each group, at least one CSI component (e.g., at least one of rank indicator (RI), precoding matrix indicator (PMI), or channel quality indicator (CQI)) for common CSI reporting.

Processor 120 can determine CSI information associated with the DL cells. In conventional LTE systems, individual values for each CSI component are separately determined for each DL cell. In accordance with aspects described herein, however, the processor 120 can calculate, for each group, a group value of each of the at least one CSI components designated for common CSI reporting instead of calculating individual values for each DL cell. Additionally, the processor 120 can calculate, if necessary, individual values for any additional CSI components (e.g., those not designated for common reporting for the group). The processor 120 can calculate these individual values for each DL cell of each group. In aspects, individual values of CSI components can be calculated based on the group values calculated for the group.

In one example, RI is designated for common CSI reporting for a first group, and the processor 120 calculates a group value for RI for the first group and individual values for PMI and CQI for each DL cell of the first group based on the group value for RI. In another example, RI and PMI are designated for common CSI reporting for a first group, and the processor 120 calculates group values for RI and PMI for the first group and individual values for CQI for each DL cell of the first group based on the group values for RI and PMI. In a third example, RI, PMI, and CQI are designated for common CSI reporting for a first group, and the processor 120 calculates group values for RI, PMI, and CQI for the first group.

In various aspects, the CSI configuration information can indicate (for one or more of the groups) a reference DL cell associated with the group. In embodiments with reference DL cells, each group value of the at least one CSI component can correspond to the individual value calculated for the reference DL cell of that group. In embodiments without reference DL cells, group values can be calculated in a variety of manners for a group. For example, the processor 120 can perform a joint optimization to determine the at least one group value (for example, based on individual channel and interference conditions for some or all of the DL cells of the group).

Transmitter circuit 130 can transmit, as CSI feedback, the CSI values calculated by the processor 120. This can include transmitting the group values for each group, as well as any individual values for each DL cell of each group. In some aspects, transmitter circuit 130 can transmit the group value once for each DL cell of the group, allowing for reporting similar to conventional LTE systems, while reducing the calculations and power consumption of system 100. In other aspects, each group value can be reported only a single time, for example, as CSI feedback for a reference DL cell of the group.

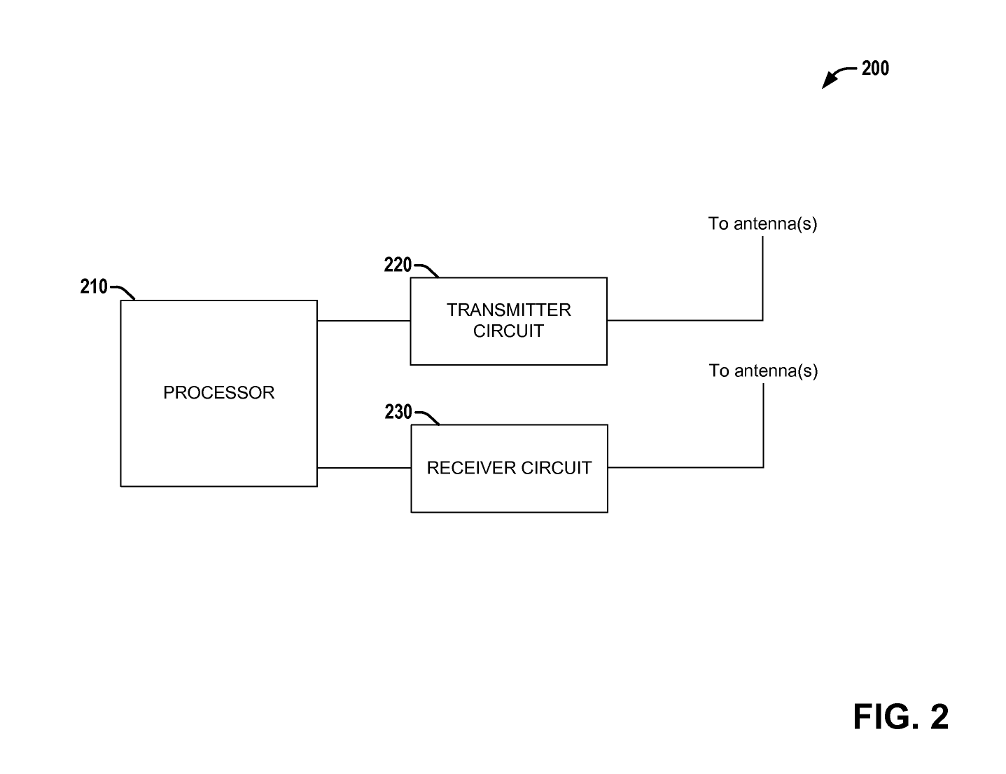

Referring to FIG. 2, illustrated is a block diagram of a system 200 that facilitates CSI configuration for common CSI reporting on a plurality of DL cells at an Evolved NodeB (eNB) according to various aspects described herein. System 200 can include a processor 210, a transmitter circuit 220, and a receiver circuit 230. Each of the receiver circuit 230 and the transmitter circuit 220 are configured to be coupled to one or more antennas, which can be the same or different antenna(s). In aspects, the receiver circuit 230 and transmitter circuit 220 can have one or more components in common, and both can be included within a transceiver circuit, while in other aspects they are not. In various aspects, system 200 can be included within an Evolved Universal Terrestrial Radio Access Network (E-UTRAN) Node B (Evolved NodeB, eNodeB, or eNB).

Processor 210 can assign a plurality of DL cells (e.g., component carriers for carrier aggregation) to one or more groups, with each group providing for common CSI reporting. Additionally, processor 210 can determine at least one common CSI component for common reporting for each group, and generate CSI configuration information for a UE indicating the one or more groups, and which common CSI component(s) are associated with each group. Depending on the embodiment, processor 210 can also designate, for some or all of the groups, a reference DL cell for use in calculating group values for common CSI components.

Grouping of DL cells for common CSI reporting can be based on proximity of the frequency bands of DL cells grouped together, which correlates with common channel and interference conditions. For example, a group can comprise a set of intra-band contiguous DL cells. In another example, a group can comprise a set of intra-band DL cells, not all of which are contiguous. In some aspects, intra-band DL cells can be grouped, but in general, intra-band grouping leads to greater similarity in channel and interference conditions, and thus in CSI component values. In embodiments with reference DL cells, any DL cell of the group can be selected as a reference DL cell. For example, a DL cell with a frequency band centrally located relative to other DL cells of the group could be selected, which would reduce an upper bound on the frequency variation between the reference DL cell and other DL cells of the group. In some aspects, a maximum number of groups of DL cells can be employed. In one embodiment, the maximum number of groups of DL cells can correspond to the current LTE-A maximum number of simultaneous DL cells for carrier aggregation of five. In other embodiments, greater or lesser number of maximum groups can be employed, while in further embodiments, no maximum number of groups can be employed.

Additionally, DL cells in each group can have common characteristics, which can depend on the CSI components designated for common reporting. For example, common RI reporting over a group of DL cells (component carriers) can involve a group of DL cells wherein the number of CRS antenna ports (or number of CSI-RS antenna ports for transmission mode (TM) 9 or 10), the CSI reporting mode, and the transmission mode for each carrier of the group and the carrier corresponding to reference DL cell are the same. In another example, common PMI and RI reporting over a group of DL can involve a group of DL cells wherein the number of CRS antenna ports, the CSI reporting mode, the transmission mode, and the set of the restricted RI in the codebook subset restriction for each carrier of the group and the carrier corresponding to the reference DL cell are the same.

Transmitter circuit 220 can transmit (e.g., to one or more UEs, etc.) the CSI configuration information generated by the processor 210, and can also transmit other signals (e.g., data payloads, etc.) over the plurality of DL cells according to a carrier aggregation (CA) mode of operation. As explained above, for DL cells grouped together for common CSI reporting, the transmission of each group of DL cells can involve multiple common transmission characteristics shared between DL cells of the group.

Receiver circuit 230 can receive CSI feedback from the one or more UEs. This feedback can include CSI component values (e.g., values for RI, PMI, and CQI) for the plurality of DL cells. These values can include group values associated with the common CSI components for each group, and individual values for each DL cell of the group for groups wherein there are CSI components other than common CSI components (e.g., if only RI or only RI and PMI are designated as common CSI components, etc.).

Processor 210 can associate received CSI component values with DL cells. For each group of DL cells, processor 210 can associate group values of CSI components with each DL cell of the group. Additionally, processor 210 can associate individual values with respective DL cells. For each DL cell, processor 210 can optionally select one or more transmission characteristics for the DL cell based at least in part on the received CSI component values associated with that DL cell. In some aspects, processor 210 can re-assign the plurality of DL cells to one or more groups based at least in part on the selected transmission characteristics (e.g., to maintain common transmission characteristics among DL cells of a group, etc.).

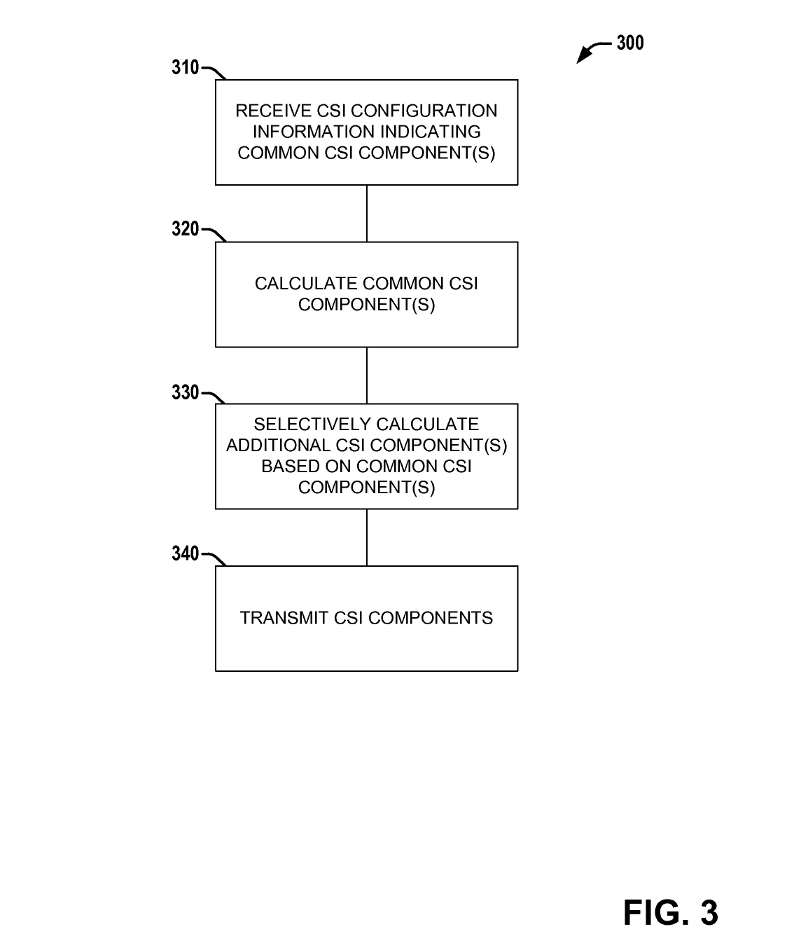

Referring to FIG. 3, illustrated is a flow diagram of a method 300 that facilitates CSI reporting for a plurality of DL cells at a UE according to various aspects described herein. In various aspects, method 300 can be implemented at a UE, for example, by executing machine-readable instructions that cause the UE to perform some or all of the acts described in connection with method 300.

Method 300 includes, at 310, receiving CSI configuration information for a group of DL cells that indicates one or more common CSI components associated with the group of DL cells.

At 320, the one or more common CSI components can be calculated for the group of DL cells. In some aspects, calculating the common CSI component(s) can include determining individual values for those components for a reference DL cell. In other aspects, calculating the common CSI component(s) can include performing a joint optimization based on channel and interference conditions of some or all of the group of DL cells.

At 330, one or more additional CSI components can optionally be calculated for each DL cell of the group based on the one or more common CSI components. For example, if only RI is designated for common CSI reporting, a common RI can be calculated, and PMI and CQI can be individually calculated. In another example, if RI, PMI, and CQI are designated for common CSI reporting, no CSI components need to be individually calculated.

At 340, method 300 can include transmitting the one or more common CSI components and optionally transmitting the one or more additional CSI components to an eNB as CSI feedback.

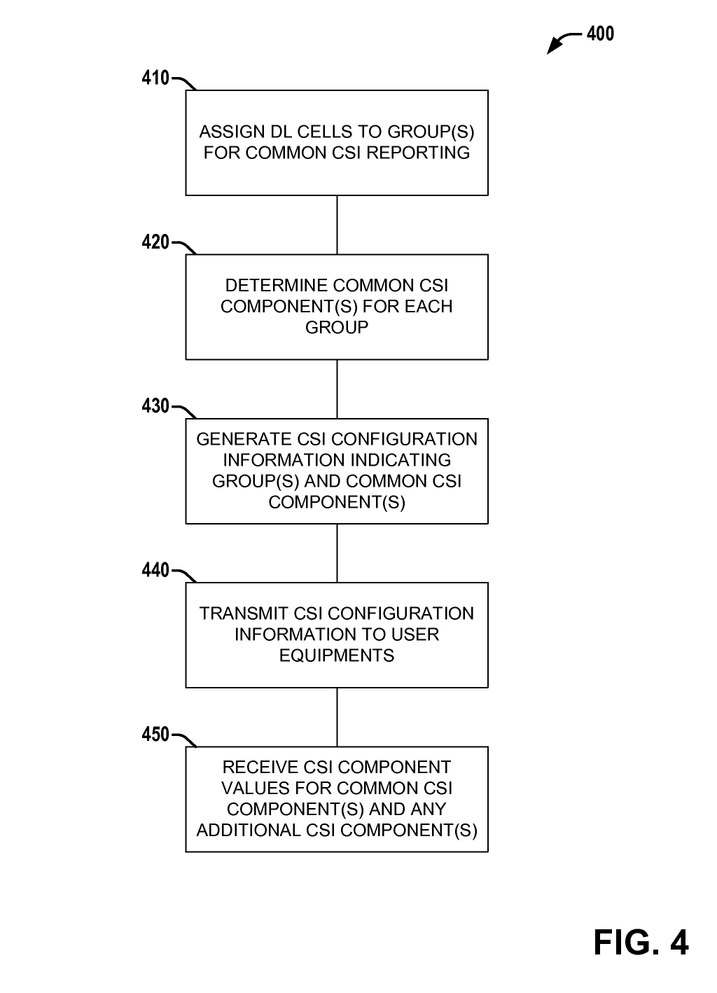

Referring to FIG. 4, illustrated is a flow diagram of a method 400 that that facilitates CSI configuration for common CSI reporting on a plurality of DL cells at an eNB according to various aspects described herein. In various aspects, method 400 can be implemented at an eNB, for example, by executing machine-readable instructions that cause the eNB to perform some or all of the acts described in connection with method 400.

Method 400 includes, at 410, assigning a plurality of DL cells to one or more groups for common CSI reporting. As discussed elsewhere herein, DL cells assigned to groups for common CSI reporting can have common characteristics, such as a common number of antenna ports, a common transmission mode, a common CSI reporting mode, a common set of restricted RI in a codebook subset restriction, etc. Additionally, because CSI reporting depends on channel and interference conditions, DL cells can be grouped with other DL cells with substantially similar channel and interference conditions, such as grouping DL cells based on the proximity of frequency ranges associated with the DL cells, for example, grouping DL cells that are intra-band contiguous or intra-band non-contiguous, although in some aspects, inter-band grouping can be employed.

At 420, one or more common CSI components (e.g., of RI, PMI, and CQI) are determined for each group. In some aspects, a reference DL cell can also be selected for the group. Fewer common CSI components will have CSI components that are reported better reflect the channel and interference conditions of individual DL cells. However, more common CSI components will reduce issues related to coverage of the control channel transmission on PUCCH/PUSCH and signaling overhead, and depending on how CSI components are calculated (e.g., based on a reference DL cell, joint optimization, etc.), can also reduce complexity and power consumption at the UE.

At 430, CSI configuration information can be generated that indicates the one or more groups and which CSI components were determined as common CSI components for each group.

At 440, the CSI configuration information can be transmitted to one or more UEs to which the plurality of DL cells are used to transmit signals (e.g., data payloads, etc.) according to a carrier aggregation (CA) mode.

At 450, CSI component values can be received from the one or more common CSI components and any additional CSI components. Based on these received values, transmission conditions of the one or more DL cells can optionally be adjusted.

The following discussion provides examples of reporting common CSI components for a DL cell for situations of common RI reporting, common RI and PMI reporting, and common CSI reporting (RI, PMI, and CQI). In a first example, common RI reporting is provided over a group of component carriers (DL cells), which can involve, for example, cross-carrier RI inheritance from one component carrier (e.g., a reference DL cell) to another component carrier. In a second example, common wideband PMI (and RI) reporting is provided over a group of component carriers (DL cells), which can involve, for example, cross-carrier PMI (and RI) inheritance from one component carrier (e.g., a reference DL cell) to another component carrier. In a third example, common wideband CSI reporting is provided over a group of component carriers (DL cells).

Aspects discussed herein involving common CSI reporting facilitates scheduling with resource allocation spanning a group of DL cells (component carriers). Aspects discussed herein can also reduce the amount of control signaling information transmitted in the uplink for CSI reporting.

### Common RI Reporting Over a Group of Component Carriers

RI reports from a UE are used to assist selection at the eNB of the number of spatial layers, which are used for transmission of physical downlink shared channel (PDSCH) signals. The actual number of selected layers are indicated to the UE in downlink control information (DCI) by using special fields (e.g., antenna port(s), scrambling identity and number of layers), and are typically common for all resource blocks within the resource allocation. If resource allocation spans more the one component carrier, the value of the RI for the component carriers can be the same.

In some aspects, the CSI configuration (periodic or aperiodic) of the component carrier can include the carrier index of a reference component carrier (DL cell) for RI reporting (e.g., a ‘RI-reference DL Cell’). If the component carrier is configured with a ‘RI-reference DL Cell,’ the calculated and reported RI for that carrier (DL Cell) can be the same as the RI calculated and reported for the carrier corresponding to the ‘RI-reference DL Cell.’ In additional aspects, the group of component carriers with common RI reporting can be configured via radio resource control (RRC) by indicating the set of DL cells grouped for common RI reporting. In further aspects, the RI of only one component carrier (e.g., corresponding to RI-reference DL Cell′) can be reported by the UE to reduce control signaling overhead in the uplink.

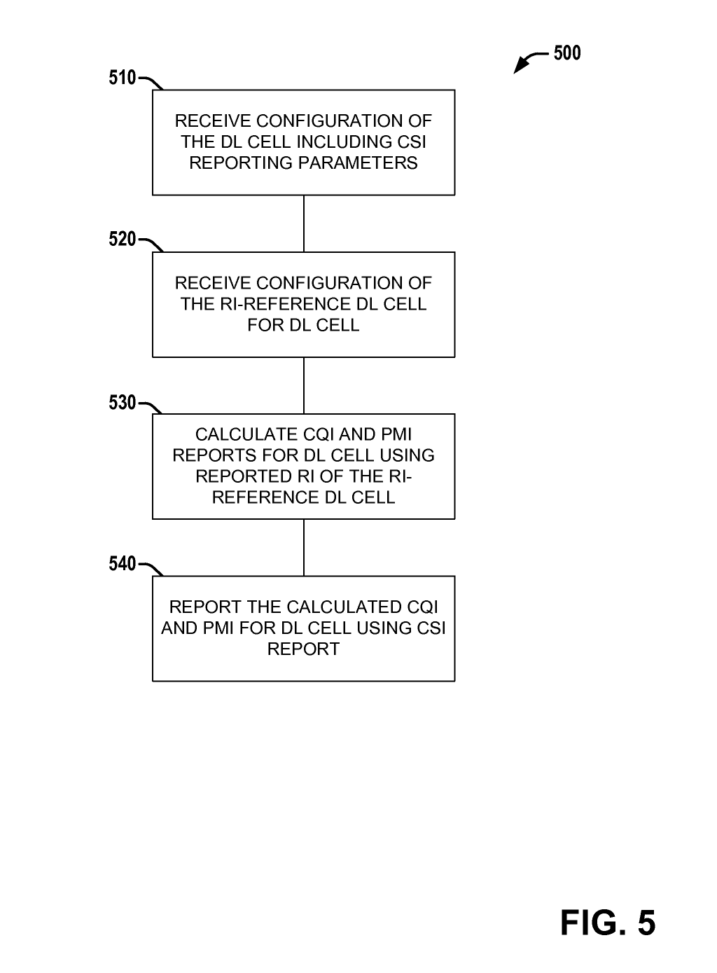

Referring to FIG. 5, illustrated is a flow diagram of an example method 500 of CSI reporting for a DL cell based on a common rank indicator (RI) according to various aspects described herein. At 510, CSI configuration information for a DL cell can be received, which can include CSI reporting parameters. At 520, configuration of a reference DL cell for common RI reporting, a ‘RI-reference DL cell,’ can be received for the DL cell. The ‘RI-reference DL cell’ can be any DL cell of the group of DL cells for common RI reporting, for example, as selected by the eNB providing configuration information. At 530, CQI and PMI of the DL cell can be calculated based on the RI calculated (and reported) for the ‘RI-reference DL cell.’ At 540, the calculated CQI and PMI for the DL cell can be reported.

For common RI reporting over a group of component carriers, the number of CRS antenna ports (or number of CSI-RS antenna ports for TM 9, 10), CSI reporting mode, transmission mode for each component carrier of the group and the component carrier corresponding to ‘RI-reference DL Cell’ can be the same.

### Common PMI Reporting Over a Group of Component Carriers

PMI reporting is used to assist precoding weight selection for the antennas of the transmitting eNB. For cell-specific reference signal (CRS) transmission modes (e.g. TM 4, 5, 6) with closed-loop CSI feedback, the PMI is usually indicated in DCI using a precoding information field and, therefore, can be the same for the component carriers if common resource allocation is used across the component carriers.

In some aspects, the CSI configuration (periodic or aperiodic) of a component carrier can include the carrier index of a reference component carrier for wideband (WB) PMI/RI reporting (e.g., a ‘WB PMI/RI-reference DL Cell’). If the component carrier is configured with a ‘WB PMI/RI-reference DL Cell,’ the calculated and reported wideband PMI (PTI if applicable) and RI for that carrier (DL Cell) can be the same as the wideband PMI and RI calculated and reported for the carrier corresponding to the ‘WB PMI/RI-reference DL Cell’. In additional aspects, the group of component carriers with common WB PMI and RI reporting can be configured via RRC signaling by indicating the set of DL cells grouped for common PMI and RI reporting. In further aspects, the WB PMI/RI of only one component carrier (e.g., corresponding to ‘WB PMI/RI-reference DL Cell’) can be reported by the UE to reduce control signaling overhead in the uplink.

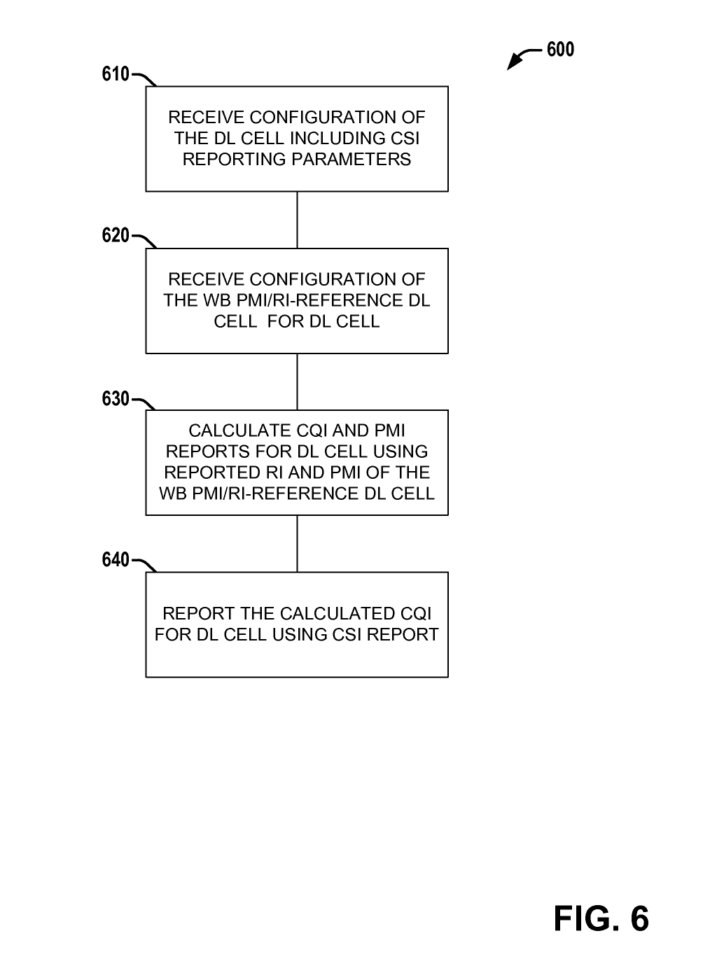

Referring to FIG. 6, illustrated is a flow diagram of an example method 600 of CSI reporting for a DL cell based on a common RI and precoding matrix indicator (PMI) according to various aspects described herein. At 610, CSI configuration information for a DL cell can be received, which can include CSI reporting parameters. At 620, configuration of a reference DL cell for common PMI and RI reporting, a ‘WB PMI/RI-reference DL cell,’ can be received for the DL cell. The ‘WB PMI/RI-reference DL cell’ can be any DL cell of the group of DL cells for common PMI and RI reporting, for example, as selected by the eNB providing configuration information. At 630, CQI of the DL cell can be calculated based on the PMI and RI calculated (and reported) for the ‘WB PMI/RI-reference DL cell.’ At 640, the calculated CQI for the DL cell can be reported.

For common PMI and RI reporting over a group of component carriers, the number of CRS antenna ports, CSI reporting mode, transmission mode, set of the restricted RI in the codebook subset restriction for the carrier and carrier corresponding to ‘WB PMI/RI-reference DL Cell’ can be the same.

### Common CSI Reporting Over Group of Component Carriers

In various embodiments, configuration for common CSI reporting can be provided for a group of DL cells (component carriers) or configuration for CSI reporting for a group of DL cells can be provided to a UE. In some aspects for common CSI reporting, the RI, wideband PMI and wideband CQI can be selected and reported by the UE based on channel and interference characteristics for some or all of the DL cells.

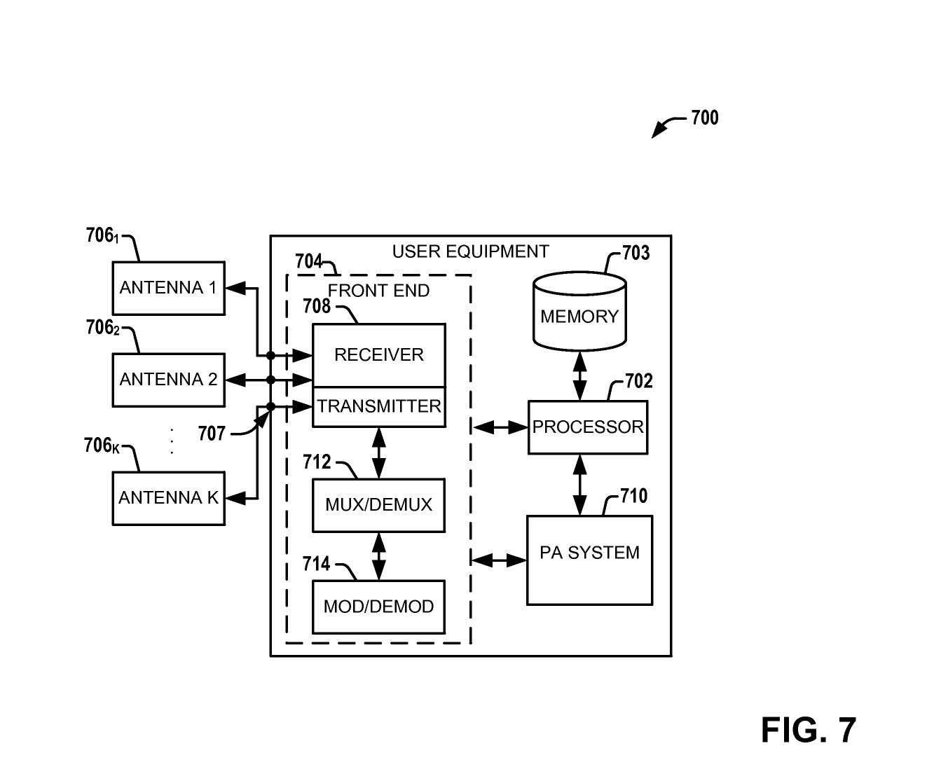

Referring to FIG. 7, illustrated is an exemplary user equipment or mobile communication device 700 that can be utilized with one or more aspects of the systems, methods, or devices facilitating communication with aggregation of downlink component carrier described herein according to various aspects. The user equipment 700, for example, comprises a digital baseband processor 702 that can be coupled to a data store or memory 703, a front end 704 (e.g., an RF front end, an acoustic front end, or the other like front end) and a plurality of antenna ports 707 for connecting to a plurality of antennas 706₁ to 706ₖ (k being a positive integer). The antennas 706₁ to 706ₖ can receive and transmit signals to and from one or more wireless devices such as access points, access terminals, wireless ports, routers and so forth, which can operate within a radio access network or other communication network generated via a network device. The user equipment 700 can be a radio frequency (RF) device for communicating RF signals, an acoustic device for communicating acoustic signals, or any other signal communication device, such as a computer, a personal digital assistant, a mobile phone or smart phone, a tablet PC, a modem, a notebook, a router, a switch, a repeater, a PC, network device, base station or a like device that can operate to communicate with a network or other device according to one or more different communication protocols or standards.

The front end 704 can include a communication platform, which comprises electronic components and associated circuitry that provide for processing, manipulation or shaping of the received or transmitted signals via one or more receivers or transmitters 708, a mux/demux component 712, and a mod/demod component 714. The front end 704, for example, is coupled to the digital baseband processor 702 and the set of antenna ports 707, in which the set of antennas 706₁ to 706ₖ can be part of the front end.

The user equipment 700 can also include a processor 702 or a controller that can operate to provide or control one or more components of the user equipment 700. For example, the processor 702 can confer functionality, at least in part, to substantially any electronic component within the user equipment 700, in accordance with aspects of the disclosure. As an example, the processor 702 can be configured to execute, at least in part, executable instructions that facilitate determination of one or more common CSI components for a group of DL cells received via at least one receiver 708, and optional determination of one or more additional CSI components based on the one or more common CSI components, in accordance with aspects described herein.

The processor 702 can operate to enable the user equipment 700 to process data (e.g., symbols, bits, or chips) for multiplexing/demultiplexing with the mux/demux component 712, or modulation/demodulation via the mod/demod component 714, such as implementing direct and inverse fast Fourier transforms, selection of modulation rates, selection of data packet formats, inter-packet times, etc. Memory 703 can store data structures (e.g., metadata), code structure(s) (e.g., modules, objects, classes, procedures, or the like) or instructions, network or device information such as policies and specifications, attachment protocols, code sequences for scrambling, spreading and pilot (e.g., reference signal(s)) transmission, frequency offsets, cell IDs, and other data for detecting and identifying various characteristics related to RF input signals, a power output or other signal components during power generation.

The processor 702 is functionally and/or communicatively coupled (e.g., through a memory bus) to memory 703 in order to store or retrieve information necessary to operate and confer functionality, at least in part, to communication platform or front end 704 including the receiver 708, and the power amplifier (PA) system 710. While the components in FIG. 7 are illustrated in the context of a user equipment, such illustration is not limited to user equipment but also extends to other wireless communication devices, such as base station (e.g., eNodeB), small cell, femtocell, macro cell, microcell, etc.

Examples herein can include subject matter such as a method, means for performing acts or blocks of the method, at least one machine-readable medium including executable instructions that, when performed by a machine (e.g., a processor with memory or the like) cause the machine to perform acts of the method or of an apparatus or system for concurrent communication using multiple communication technologies according to embodiments and examples described.

Example 1 is a user equipment (UE), comprising a receiver circuit, a processor, and a transmitter circuit. The receiver circuit is configured to receive channel state information (CSI) configuration information associated with a plurality of downlink (DL) cells for carrier aggregation (CA), wherein the CSI configuration information indicates a first group of two or more of the DL cells and at least one CSI component designated for common reporting for the first group. The processor is operably coupled to the receiver circuit and configured to calculate a group value for each of the at least one CSI components designated for common reporting for the first group; and selectively calculate, for each DL cell of the first group, individual values for any CSI components not designated for common reporting for the first group. The transmitter circuit is configured to transmit the group value for each of the at least one designated CSI components associated with the first group and the individual values for any additional CSI components for each DL cell of the first group.

Example 2 includes the subject matter of example 1, wherein the at least one CSI component designated for common reporting for the first group comprises a rank indicator (RI).

Example 3 includes the subject matter of example 2, wherein the CSI configuration information indicates a DL cell of the first group as a reference DL cell, and wherein the group value calculated for the RI is an RI calculated for the reference DL cell.

Example 4 includes the subject matter of example 3, wherein the CSI components not designated for common reporting for the first group comprise a channel quality indicator (CQI) and a precoding matrix indicator (PMI), and wherein the processor is configured to selectively calculate, for each DL cell of the first group, individual values for the CQI and the PMI based on the RI calculated for the reference DL cell.

Example 5 includes the subject matter of example 3, wherein each DL cell of the first group has a common number of antenna ports, a common CSI reporting mode, and a common transmission mode.

Example 6 includes the subject matter of any of examples 3 or 4, including or omitting optional features, wherein each DL cell of the first group has a common number of antenna ports, a common CSI reporting mode, and a common transmission mode.

Example 7 includes the subject matter of example 1, wherein the at least one CSI component designated for common reporting for the first group comprises a rank indicator (RI) and a precoding matrix indicator (PMI).

Example 8 includes the subject matter of example 7, wherein the CSI configuration information indicates a DL cell of the first group as a reference DL cell, and wherein the group values calculated for the RI and PMI are an RI calculated for the reference DL cell and a PMI calculated for the reference DL cell, respectively.

Example 9 includes the subject matter of example 8, wherein the CSI components not designated for common reporting for the first group comprise a channel quality indicator (CQI), and wherein the processor is configured to selectively calculate, for each DL cell of the first group, individual values for the CQI based on the RI and the PMI calculated for the reference DL cell.

Example 10 includes the subject matter of example 8, wherein each DL cell of the first group has a common number of antenna ports, a common CSI reporting mode, a common transmission mode, and a common set of restricted RIs based on codebook subset restrictions.

Example 11 includes the subject matter of any of examples 8 or 9, including or omitting optional features, wherein each DL cell of the first group has a common number of antenna ports, a common CSI reporting mode, a common transmission mode, and a common set of restricted RIs based on codebook subset restrictions.

Example 12 includes the subject matter of example 1, wherein the at least one CSI component designated for common reporting for the first group comprises a rank indicator (RI), a precoding matrix indicator (PMI), and a channel quality indicator (CQI).

Example 13 includes the subject matter of example 12, wherein the processor is configured to calculate the group values based on an analysis of channel and interference conditions for each of the DL cells of the first group.

Example 14 is a non-transitory machine readable medium comprising instructions that, when executed, cause a user equipment (UE) to receive channel state information (CSI) configuration information of a plurality of downlink (DL) cells, wherein the CSI configuration information indicates a reference DL cell of the plurality of DL cells and at least one common CSI component associated with the plurality of DL cells; calculate the at least one common CSI component based at least in part on channel and interference characteristics of the reference DL cell; calculate one or more additional CSI components for each of the plurality of DL cells based at least in part on the at least one common CSI component; and transmit the at least one common CSI component and the one or more additional CSI components.

Example 15 includes the subject matter of example 14, wherein the at least one common CSI component comprises a rank indicator (RI), and the one or more additional components comprise a precoding matrix indicator (PMI) and a channel quality indicator (CQI).

Example 16 includes the subject matter of example 14, wherein the at least one common CSI component comprises a rank indicator (RI) and a precoding matrix indicator (PMI), and the one or more additional components comprise a channel quality indicator (CQI).

Example 17 includes the subject matter of example 14, wherein transmitting the at least one common CSI component comprises transmitting the at least one common CSI component for the reference DL cell only.

Example 18 includes the subject matter of any of examples 14-16, including or omitting optional features, wherein transmitting the at least one common CSI component comprises transmitting the at least one common CSI component for the reference DL cell only.

Example 19 includes the subject matter of example 14, wherein transmitting the at least one common CSI component comprises transmitting the at least one common CSI component for each of the plurality of DL cells.

Example 20 includes the subject matter of example 14, wherein the instructions, when executed, further cause the UE to receive an indication of the plurality of DL cells associated with the at least one common CSI component via a radio resource control (RRC) signal.

Example 21 includes the subject matter of example 14, wherein each of the plurality of DL cells has a common number of antenna ports, a common CSI reporting mode, a common transmission mode, and common feedback types.

Example 22 is an Evolved NodeB (eNB), comprising a processor, a transmitter circuit, and a receiver circuit. The processor is configured to assign a plurality of downlink (DL) cells to one or more groups of DL cells for common channel state information (CSI) reporting; determine, for each of the one or more groups, at least one common CSI component, wherein the at least one common CSI component comprises at least one of a rank indicator (RI), a precoding matrix indicator (PMI), and a channel quality indicator (CQI); and generate CSI configuration information that indicates the one or more groups and the at least one common CSI component for each of the one or more groups. The transmitter circuit is configured to transmit the CSI configuration information to at least one user equipment (UE) and to transmit a data payload to the at least one UE via the plurality of DL cells according to a carrier aggregation (CA) mode. The receiver circuit is configured to receive CSI component values for each of the one or more groups, wherein the CSI component values for each of the one or more groups comprise values for the at least one common CSI component for each of the one or more groups.

Example 23 includes the subject matter of example 22, wherein the processor is further configured to determine a reference DL cell for each of the one or more groups.

Example 24 includes the subject matter of example 23, wherein the at least one common CSI component comprises the rank indicator (RI).

Example 25 includes the subject matter of example 23, wherein the at least one common CSI component comprises the rank indicator (RI) and the precoding matrix indicator (PMI).

Example 26 includes the subject matter of example 23, wherein, for each of the one or more groups, each DL cell of the group has a common number of antenna ports, a common CSI reporting mode, a common transmission mode, and common feedback types.

Example 27 includes the subject matter of example 22, wherein the processor is further configured to assign, for each of the one or more groups, the values for the at least one common CSI component to each DL cell of the group.

Example 28 includes the subject matter of any of examples 22-26, including or omitting optional features, wherein the processor is further configured to assign, for each of the one or more groups, the values for the at least one common CSI component to each DL cell of the group.

Example 29 is a user equipment (UE), comprising means for receiving, means for processing, and means for transmitting. The means for receiving is configured to receive channel state information (CSI) configuration information associated with a plurality of downlink (DL) cells for carrier aggregation (CA), wherein the CSI configuration information indicates a first group of two or more of the DL cells and at least one CSI component designated for common reporting for the first group. The means for processing is operably coupled to the means for receiving and configured to calculate a group value for each of the at least one CSI components designated for common reporting for the first group; and selectively calculate, for each DL cell of the first group, individual values for any CSI components not designated for common reporting for the first group. The means for transmitting is configured to transmit the group value for each of the at least one designated CSI components associated with the first group and the individual values for any additional CSI components for each DL cell of the first group.

Example 30 is an Evolved NodeB (eNB), comprising means for processing, means for transmitting, and means for receiving. The means for processing is configured to assign a plurality of downlink (DL) cells to one or more groups of DL cells for common channel state information (CSI) reporting; determine, for each of the one or more groups, at least one common CSI component, wherein the at least one common CSI component comprises at least one of a rank indicator (RI), a precoding matrix indicator (PMI), and a channel quality indicator (CQI); and generate CSI configuration information that indicates the one or more groups and the at least one common CSI component for each of the one or more groups. The means for transmitting configured to transmit the CSI configuration information to at least one user equipment (UE) and to transmit a data payload to the at least one UE via the plurality of DL cells according to a carrier aggregation (CA) mode. The means for receiving configured to receive CSI component values for each of the one or more groups, wherein the CSI component values for each of the one or more groups comprise values for the at least one common CSI component for each of the one or more groups.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

What is claimed is:

1. A user equipment (UE), comprising:
a receiver circuit configured to receive channel state information (CSI) configuration information associated with a plurality of downlink (DL) cells for carrier aggregation (CA), wherein the CSI configuration information indicates a first group of two or more of the DL cells and at least one CSI component designated for common reporting for the first group;
a processor operably coupled to the receiver circuit and configured to:
calculate a group value for each of the at least one CSI components designated for common reporting for the first group; and
selectively calculate, for each DL cell of the first group, individual values for any CSI components not designated for common reporting for the first group; and
a transmitter circuit configured to transmit the group value for each of the at least one designated CSI components associated with the first group and the individual values for any additional CSI components for each DL cell of the first group.

2. The UE of claim 1, wherein the at least one CSI component designated for common reporting for the first group comprises a rank indicator (RI).

3. The UE of claim 2, wherein the CSI configuration information indicates a DL cell of the first group as a reference DL cell, and wherein the group value calculated for the RI is an RI calculated for the reference DL cell.

4. The UE of claim 3, wherein the CSI components not designated for common reporting for the first group comprise a channel quality indicator (CQI) and a precoding matrix indicator (PMI), and wherein the processor is configured to selectively calculate, for each DL cell of the first group, individual values for the CQI and the PMI based on the RI calculated for the reference DL cell.

5. The UE of claim 3, wherein each DL cell of the first group has a common number of antenna ports, a common CSI reporting mode, and a common transmission mode.

6. The UE of claim 1, wherein the at least one CSI component designated for common reporting for the first group comprises a rank indicator (RI) and a precoding matrix indicator (PMI).

7. The UE of claim 6, wherein the CSI configuration information indicates a DL cell of the first group as a reference DL cell, and wherein the group values calculated for the RI and PMI are an RI calculated for the reference DL cell and a PMI calculated for the reference DL cell, respectively.

8. The UE of claim 7, wherein the CSI components not designated for common reporting for the first group comprise a channel quality indicator (CQI), and wherein the processor is configured to selectively calculate, for each DL cell of the first group, individual values for the CQI based on the RI and the PMI calculated for the reference DL cell.

9. The UE of claim 7, wherein each DL cell of the first group has a common number of antenna ports, a common CSI reporting mode, a common transmission mode, and a common set of restricted RIs based on codebook subset restrictions.

10. The UE of claim 1, wherein the at least one CSI component designated for common reporting for the first group comprises a rank indicator (RI), a precoding matrix indicator (PMI), and a channel quality indicator (CQI).

11. The UE of claim 10, wherein the processor is configured to calculate the group values based on an analysis of channel and interference conditions for each of the DL cells of the first group.

12. A non-transitory machine readable medium comprising instructions that, when executed, cause a user equipment (UE) to:
receive channel state information (CSI) configuration information of a plurality of downlink (DL) cells, wherein the CSI configuration information indicates a reference DL cell of the plurality of DL cells and at least one common CSI component associated with the plurality of DL cells;
calculate the at least one common CSI component based at least in part on channel and interference characteristics of the reference DL cell;
calculate one or more additional CSI components for each of the plurality of DL cells based at least in part on the at least one common CSI component; and
transmit the at least one common CSI component and the one or more additional CSI components.

13. The non-transitory machine readable medium of claim 12, wherein the at least one common CSI component comprises a rank indicator (RI), and the one or more additional components comprise a precoding matrix indicator (PMI) and a channel quality indicator (CQI).

14. The non-transitory machine readable medium of claim 12, wherein the at least one common CSI component comprises a rank indicator (RI) and a precoding matrix indicator (PMI), and the one or more additional components comprise a channel quality indicator (CQI).

15. The non-transitory machine readable medium of claim 12, wherein transmitting the at least one common CSI component comprises transmitting the at least one common CSI component for the reference DL cell only.

16. The non-transitory machine readable medium of claim 12, wherein transmitting the at least one common CSI component comprises transmitting the at least one common CSI component for each of the plurality of DL cells.

17. The non-transitory machine readable medium of claim 12, wherein the instructions, when executed, further cause the UE to receive an indication of the plurality of DL cells associated with the at least one common CSI component via a radio resource control (RRC) signal.

18. The non-transitory machine readable medium of claim 12, wherein each of the plurality of DL cells has a common number of antenna ports, a common CSI reporting mode, a common transmission mode, and common feedback types.

19. The non-transitory machine readable medium of claim 12, wherein the instructions, when executed, cause the user equipment (UE) to only transmit the at least one common CSI component in connection with the reference DL cell.

20. An Evolved NodeB (eNB), comprising:
a processor configured to:
assign a plurality of downlink (DL) cells to one or more groups of DL cells for common channel state information (CSI) reporting;
determine, for each of the one or more groups, at least one common CSI component, wherein the at least one common CSI component comprises at least one of a rank indicator (RI), a precoding matrix indicator (PMI), and a channel quality indicator (CQI); and
generate CSI configuration information that indicates the one or more groups and the at least one common CSI component for each of the one or more groups;
a transmitter circuit configured to transmit the CSI configuration information to at least one user equipment (UE) and to transmit a data payload to the at least one UE via the plurality of DL cells according to a carrier aggregation (CA) mode; and
a receiver circuit configured to receive CSI component values for each of the one or more groups, wherein the CSI component values for each of the one or more groups comprise values for the at least one common CSI component for each of the one or more groups.

21. The eNB of claim 20, wherein the processor is further configured to determine a reference DL cell for each of the one or more groups.

22. The eNB of claim 21, wherein the at least one common CSI component comprises the rank indicator (RI).

23. The eNB of claim 21, wherein the at least one common CSI component comprises the rank indicator (RI) and the precoding matrix indicator (PMI).

24. The eNB of claim 21, wherein, for each of the one or more groups, each DL cell of the group has a common number of antenna ports, a common CSI reporting mode, a common transmission mode, and common feedback types.

25. The eNB of claim 20, wherein the processor is further configured to assign, for each of the one or more groups, the values for the at least one common CSI component to each DL cell of the group.
